(19) United States
(12) Patent Application Publication
(10) Pub. No.: US 2024/0418605 A1
(43) Pub. Date: Dec. 19, 2024

(54) FIXING PLATFORM FOR USE WITH INDUSTRIAL ROBOT AND METHOD OF AUTOMATICALLY MEASURING BACKLASH OF GEAR

(71) Applicant: ABB SCHWEIZ AG, Baden (CH)

(72) Inventors: Yongkang Zhang, Shanghai (CN); Xiwang Ji, Shanghai (CN); Yin Tian, Shanghai (CN)

(21) Appl. No.: 18/820,735

(22) Filed: Aug. 30, 2024

Related U.S. Application Data
(63) Continuation of application No. PCT/CN2022/081767, filed on Mar. 18, 2022.

(51) Int. Cl. G01M 13/021; B25J 9/16; B25J 19/00

(52) U.S. Cl. CPC G01M 13/021; B25J 9/1674; B25J 19/0008

(57) ABSTRACT

A fixing platform and a method of automatically measuring a backlash of a gear. The fixing platform includes a baseplate, a securing component provided on the baseplate; a balancing weight coupled to a terminal arm of an industrial robot; and a cylinder provided on the baseplate and adjacent to the securing component. The cylinder includes a plunger configured to move along a first direction to clamp the balancing weight when the balancing weight is coupled to the securing component.

### FIELD

Example embodiments of the present disclosure generally relate to the field of industrial robot, and more particularly, to a fixing platform and a method of automatically measuring a backlash of a gear.

### BACKGROUND

In the system structure of industrial robot, the mechanical arms of the industrial robot are driven by power sources such as servo motor and corresponding gears. Although the gear is proved in practice to have the highest transmission, there is also a problem, that is, the clearance of gear. Since the gear clearance represents the performance of the accuracy of gear, regular inspection and testing in order to find faults and analyze the causes in time are particularly critical. Therefore, how to monitor the performance of the industrial robot in real time remains a challenge.

### SUMMARY

In general, example embodiments of the present disclosure provide a fixing platform to assist in measuring a backlash of a gear.

In a first aspect, there is provided a fixing platform. The fixing platform comprises a baseplate, a securing component provided on the baseplate; a balancing weight coupled to a terminal arm of an industrial robot; and a cylinder provided on the baseplate and adjacent to the securing component. The cylinder comprising a plunger configured to move along a first direction to clamp the balancing weight when the balancing weight is coupled to the securing component.

According to example embodiments, the fixing platform can be used for measuring the backlash of the gear automatically without human intervention, thereby improving the efficiency of the measuring.

In some example embodiments, the securing component comprises: a base part coupled to the baseplate; a first protrusion extending from the base part; a second protrusion extending from the base part, wherein the second protrusion is spaced from the first protrusion along a second direction perpendicular to the first direction to form a gap between the first protrusion and the second protrusion. With these embodiments, the terminal arm of the industrial robot can automatically follow the predetermined route to completely insert the balancing weight into the gap of the securing component.

In some example embodiments, the plunger comprises a plunger face towards the first protrusion and the second protrusion, and the first protrusion and the second protrusion each comprises a protrusion face towards the plunger, wherein the protrusion face is parallel to the plunger face, such that the balancing weight can be clamped between the protrusion face and the plunger face when the balancing weight is coupled to the securing component. With these embodiments, the balancing weight can be firmly clamped.

In some example embodiments, the balancing weight is coupled to the terminal arm of the industrial robot via a linkage, and wherein the linkage can be accommodated within the gap when the balancing weight is coupled to the securing component such that the balancing weight can be supported by the first protrusion and the second protrusion. With these embodiments, the measuring test can be carried out in a cost effective manner.

In some example embodiments, the plunger can be actuated hydraulically, pneumatically or electrically. With these embodiments, the user can use the fixing platform to measure the backlash of the gear in a plurality of manners.

In some example embodiments, the fixing platform further comprises: a base coupled to a stationary body, wherein the baseplate is coupled to the base. With these embodiments, the fixing platform can be firmly secured to in position.

In some example embodiments, the fixing platform further comprises: an image capturing module provided adjacent to the securing component and configured to assist in the positioning of the balancing weight onto the securing component. With these embodiments, the collision can be avoided when the balancing weight is actuated under a predetermined route.

In some example embodiments, the stationary body is the ground. With these embodiments, the fixing platform can be firmly secure to ensure precise measuring result.

In a second aspect, there is provided a method of automatically measuring a backlash of a gear. The gear is coupled between an input shaft and an output shaft, the input shaft being coupled to a motor. The method comprising: securing the output shaft by means of the fixing platform; causing the motor to provide a torque for the input shaft to allow the gear to rotate by a degree under the torque; and obtaining the torque and rotated degree of the gear; and determining the backlash of the gear based on the torque and the rotated degree. With these embodiments, this process reduces the cost of manpower and materials, reduces errors and improves the test frequency and utilization.

In some example embodiments, the securing the output shaft is achieved by the fixing platform of the first aspect.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates a backlash in a transmission gear;

FIG. 2 illustrates a principle of measuring the backlash of a gear according to a traditional method;

FIG. 3 illustrates an example hysteretic curve;

FIG. 4 illustrates a principle of measuring the backlash of a gear according to the present disclosure;

FIG. 5 illustrates a schematic view of an industrial robot in accordance with an example embodiment of the present disclosure;

FIG. 6 illustrates a side view of the industrial robot of FIG. 5;

FIG. 7 illustrates a schematic view of the fixing platform for use with the industrial robot of FIG. 5; and

FIG. 8 illustrates a method of automatically measuring a backlash of a gear according to the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As mentioned above, the backlash of a gear should be monitored in real time to ensure the performance of the corresponding industrial robot. The detail of the present disclosure will be described afterwards.

FIG. 1 illustrates a backlash in a transmission gear. The backlash, which is indicated by D, exists between two gears 102, 104. The gear 102 may be coupled to an input device (not shown) and the gear 104 may be coupled to an output device (not shown). In such a situation, the gear 102 operates as a driving gear while the gear 104 operates as a driven gear.

The backlash D can be incurred by many factors, for example, a gear wear. The gear wear of any of the gears 102, 104 will reduce transmission accuracy thereof, which causes inaccurate transmission and reduces the service life of the gears 102, 104. If the clearance between the gears 102, 104 is too large, the thickness of the gear teeth will be too small, which will affect the strength. Especially for the gear transmission system that needs to realize forward and reverse rotation, the improper backlash D will have a great impact during speed change. It is easy to cause tooth breakage and other failures. The large meshing clearance may be due to processing or design problems. If there are no problems in part design and processing, the large meshing clearance is probably due to large center distance error, in this case, the meshing of gears is not a normal state, which results in increased wear, reduced coincidence coefficient and reduced motion transmission accuracy.

Therefore, how to accurately measure the backlash of the gears is a key point to monitor the performance of the gears in real time.

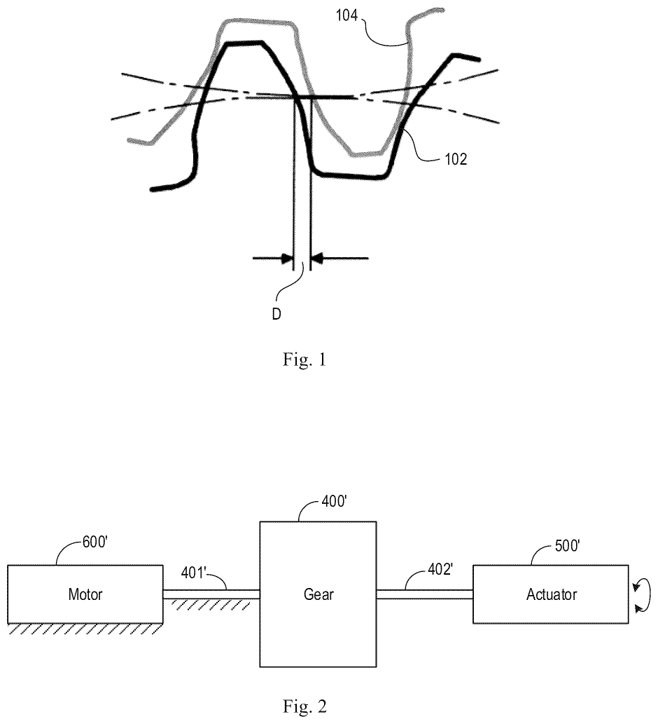

Conventionally, many approaches are presented to measure the backlash of the gear. FIG. 2 illustrates a principle of measuring the backlash of a gear according to a traditional method. As can be seen in FIG. 2, the gear 400′ is couple to a motor 600′ by an input shaft 401′ and coupled to an actuator 500′ by an output shaft 402′. The actuator 500′ may be a mechanical arm of an industrial robot.

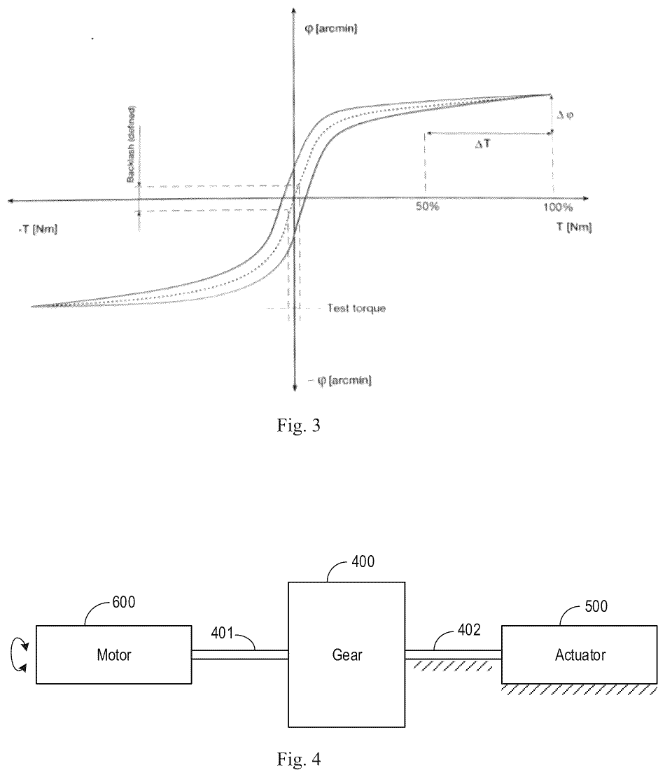

As shown, the traditional measurement method is to first fix the input end of the gear 400′. The input end includes the motor 600′ and the input shaft 401′. Afterwards, a force is continuously applied to a torque meter in both rotation directions of the output end of the gear 400′ to overcome the friction in the gearbox, and then unload gradually. The output end includes the actuator 500′ and the output shaft 402′. In the whole process, the input end of the gear 400′ will move at a small angle, which is called return clearance. A device is used to record the angular profile over the torque. A closed curve is obtained which is called a hysteretic curve. FIG. 3 illustrates an example hysteretic curve. The hysteretic curve can directly reflect the relationship between the force and displacement between teeth of the gear 400′, which is regarded as a load displacement curve. In the curve, it can be determined how much displacement is generated between teeth under the action of a certain force.

In a word, the traditional gear clearance measurement method is to fix the motor 600′ and the input shaft 401′, apply torque to the output end and calculate the backlash value. However, many disadvantages may be obvious.

For example, it is necessary to manually build a test environment for each robot axis. Therefore, many complex equipment have to be involved including force sensor, displacement sensor and data acquisition card. Moreover, in the process of frequent disassembly and assembly of test equipment, an installation error may be caused, thus affecting the test accuracy. Worse still, applying torque to the output end is operated manually. This means the magnitude of the torque is not under a precise control. This is probably taking risk of damaging parts.

In order to at least address the above mentioned drawbacks, a new method of automatically measuring the backlash and a corresponding fixing platform is proposed in the present disclosure. In order to solve the limitations of the current gear clearance test method, the invention adopts a new integrated automatic technical test solution, adopts a kind of contrary design idea compared with the traditional method.

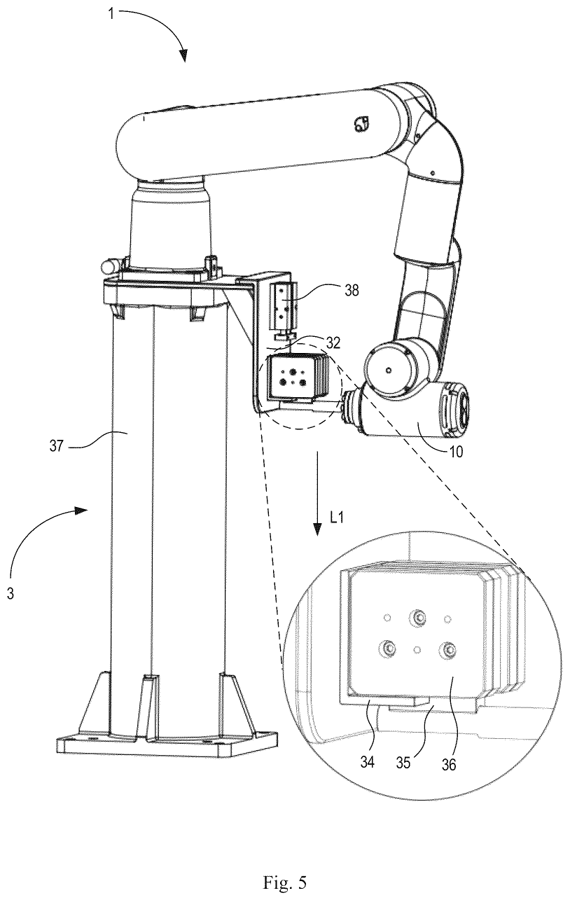

Example embodiments will be described in more detail hereinafter with reference to FIGS. 4-8.

FIG. 4 illustrates a principle of measuring the backlash of a gear according to the present disclosure. As can be seen from FIG. 4, the gear 400 is couple to a motor 600 by an input shaft 401 and coupled to an actuator 500 by an output shaft 402. Contrary to the traditional method, the present invention takes the fixed output end as the standard; the input end is applied with the specified torque by the motor. The input end includes the motor 600 and the input shaft 401, and the output end includes the actuator 500 and the output shaft 402. The actuator 500 may be a mechanical arm of an industrial robot. By fixing the actuator 500 and the output shaft 402 while causing the motor 600 and the input shaft 401 to rotate, the system does not need the participation of any external measuring equipment, such as the torque meter and displacement sensor used in the traditional methods. Instead, during the measurement, the motor 600 operates as the input and a signal inside the robot controller can be collected to obtain the angular displacement and torque in real time.

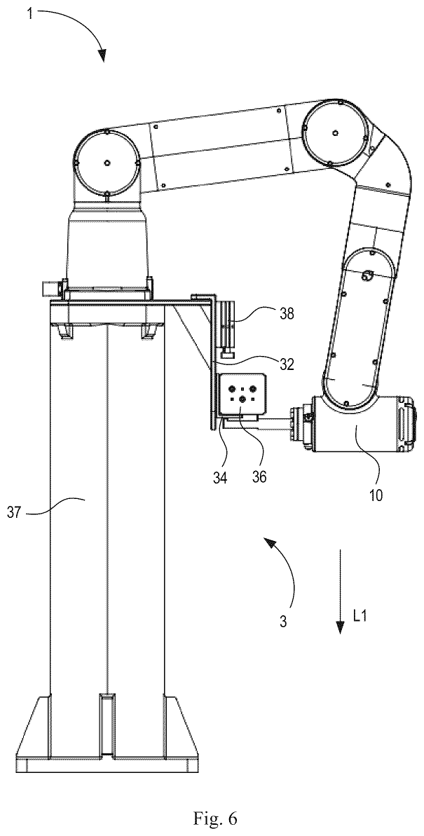

FIGS. 5-6 illustrate a schematic and a side view of an industrial robot in accordance with an example embodiment of the present disclosure, respectively.

As illustrated in FIG. 5, the fixing platform 3 generally includes a baseplate 32, a securing component 34, a balancing weight 36 and a cylinder 38. The securing component 34 and the cylinder 38 are provided adjacent to each other on the baseplate 32 and used to clamp the balancing weight 36, which is coupled to a terminal arm 10 of the industrial robot 1. The cylinder 38 includes a plunger 380, which is design to move along a first direction L1. When the balancing weight 36 is actuated to move adjacent to the securing component 34, it can be finally located and firmly clamped between the plunger 380 and the securing component 34.

In other example embodiments, the terminal arm 10 and the balancing weight 36 can be moved in various manners. For example, the terminal arm 10 can be actuated hydraulically, pneumatically or electrically to be located onto the baseplate 32 between the plunger 380 of the cylinder 38 and the securing component 34. Since the whole fixing platform 3 can be operated for use with the terminal arm 10, the measurement of the backlash of the gear can be carried out continuously with any human intervention.

In other example embodiments, the plunger 380 can be actuated in a hydraulic manner. Also, in other example embodiments, the plunger 380 can be actuated in a pneumatic manner. In other example embodiments, the plunger 380 can be actuated in an electric manner. With these embodiments, the user can use the fixing platform to measure the backlash of the gear in a plurality of manners.

According to the example embodiment of the present disclosure, the balancing weight 36 and the terminal arm 10 can be automatically moved to the desired position between the plunger 380 and the securing component 34. In further example embodiment, such a movement can be carried out under a route, which is determined in advance through experimental or simulating methods.

In some example embodiments, the balancing weight 36 and the terminal arm 10 may be moved to the desired position with various poses. Through these poses, the equations under different measuring conditions can be obtained. Based on these equations, the backlash of the gear 10 can be determined.

According to the present disclosure, the measurement is carried out under the condition of balancing weight 36 at the end of the terminal arm 10 of the industrial robot 1 to verify the end positioning accuracy and fully investigate the impact of the rated load of balancing weight 36 on the movement performance of the industrial robot 1. After the measurement is completed, the backlash will be detected to verify that the backlash is within the acceptable error range. This measuring method according to the present disclosure directly uses the balancing weight 36 to cooperate with the securing component 34 and the automatic movement of the industrial robot 1 aligned with predefined route. The industrial robot 1 itself automatically fixes its end by balancing weight 36. According to the set trajectory, the industrial robot 1 inserts the balancing weight 36 into the slot in different poses, so that the specific axis can be in a good holding state by changing the robot pose. Also, the pose guarantees that the rigidity of the axis to be measured is in good status. In addition, the different poses of the industrial robot 1 represent the meshing of different gears. Therefore, the backlash under different meshing states can be obtained. By calculating the average value, a more comprehensive and overall understanding of analyzing the backlash can be obtained.

In some example embodiments, the degree of freedom of the whole system can be reduced to zero through simple calculations. Once the terminal arm 10 of the industrial robot 1 is placed and secure to the baseplate 32, the industrial robot 1 can be kept stationary and cannot move. According to the example embodiments, with the help of the fixing platform 3, the relative movements between the arms within the whole system are inhibited. In this way, for the gear connecting the arms, the fixing platform 3 provides a situation where the output end of the gear can be kept stationary. In such a circumstance, a motor 600 may apply a specified torque to measure the backlash of the gear, which has been discussed above.

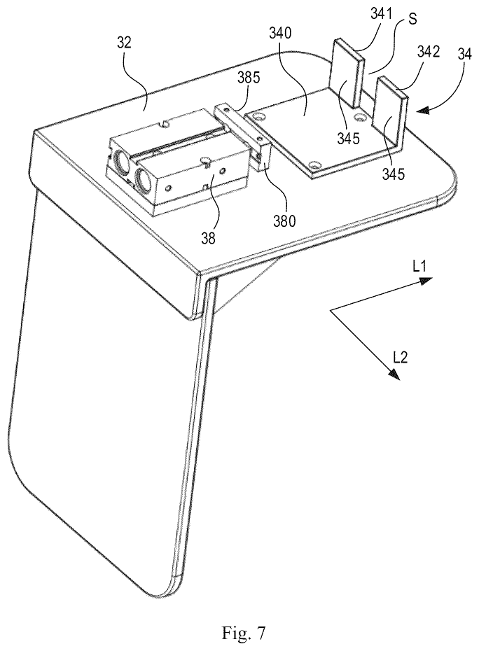

FIG. 7 illustrates a schematic view of the fixing platform 3 for use with the industrial robot 1 of FIG. 5. In the illustrated embodiments, the securing component 34 may comprise a base part 340 which is coupled to the baseplate 32. A first protrusion 341 and a second protrusion 342 extend from the base part 340. The second protrusion 342 is spaced from the first protrusion 341 along a second direction L2 normal to the first direction L1 to form a gap S between the first protrusion 341 and the second protrusion 342.

With reference to FIG. 7, in the illustrated embodiments, the plunger 380 may comprise a plunger face 385 towards the first protrusion 341 and the second protrusion 342. The first protrusion 341 and the second protrusion 342 each comprises a protrusion face 345 towards the plunger 380. The protrusion face 345 is parallel to the plunger face 385. With these embodiments, when the balancing weight 36 is actuated into the space between the protrusion face 345 and the plunger face 385, the plunger 380 can move towards the protrusion face 345. Once the plunger face 385 touches the surface of the balancing weight 36, the balancing weight 36 can be firmly clamped.

As illustrated in the enlarged view of FIG. 5, in some example embodiments, the balancing weight 36 may be coupled to the terminal arm 10 of the industrial robot 1 via a linkage 35. The linkage 35 can be accommodated within the gap S when the balancing weight 36 is coupled to the securing component 34. In this way, the balancing weight 36 can be supported by the first protrusion 341 and the second protrusion 342 to ensure a stable clamping.

As illustrated in FIG. 7, in some example embodiments, the fixing platform 3 further comprises a base 37 coupled to a stationary body, and the baseplate 32 is coupled to the base 37. In further embodiments, the stationary body may be the ground. With these embodiments, the fixing platform 3 can be firmly secured.

In some example embodiments, the fixing platform 3 may further comprise an image capturing module. The image capturing module may be provided adjacent to the securing component 34. As time goes by, the predetermined route may be inaccurate due to for example, the looseness of the components. With the embodiments discussed herein, the image capturing module may determine the position of the balancing weight 36 accurately and in real time, thus helping the balancing weight 36 to be positioned onto the securing component 34.

In a second aspect, there is provided a method of automatically measuring a backlash of a gear 400. The gear 400 is coupled between an input shaft 401 and an output shaft 402, the input shaft 401 being coupled to a motor 600. The method comprising: securing the output shaft 402 by means of the fixing apparatus 2 discussed above; causing the motor 600 to provide a torque for the input shaft 401 to allow the gear 400 to rotate by a degree under the torque; and obtaining the torque and rotated degree of the gear 400; and determining the backlash of the gear 400 based on the torque and the rotated degree. In some further example embodiment, the above processes may be conducted several times to achieve the averaging value of the test result, which ensures the accuracy of the results.

According to the present disclosure, since the terminal arm 10 of the industrial robot 1 is operated automatically, the measurement will not be interrupted in the whole course. Also, no human intervention is required. In this way, the measurement results can be obtained more quickly, and the measurement efficiency can be greatly enhanced.

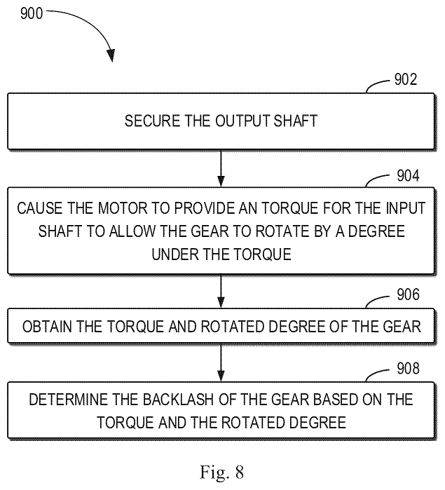

FIG. 8 illustrates a method 900 of automatically measuring a backlash of a gear 400 according to the present disclosure. With reference to FIG. 4, the gear 400 is coupled between an input shaft 401 and an output shaft 402, the input shaft 401 being coupled to the motor 600 and the output shaft 402 is coupled to the actuator 500. At block 902, the output shaft 402 is secured. In some example embodiment, the securing can be achieved by means of the fixing platform 3 discussed above. At block 904, the motor 600 is caused to provide a torque for the input shaft 401 to allow the gear 400 to rotate by a degree under the torque. At block 906, the torque and rotated degree of the gear 400 are obtained. At block 908, the backlash of the gear 400 is determined based on the torque and the rotated degree.

According to example embodiments, the output end is fixed through the fixing apparatus 2, and the motor torque change can be used as the input end. In this situation, a controller software algorithm controls the motor rotation and collects, calculates, analyzes and processes the data in real time. The whole automatic process eliminates human errors, saves time and effort in building the test environment and the test process is simple and efficient. In this way, the measuring time is greatly shorted, the process is simplified, the measuring errors can be minimized, the test frequency and utilization can be improved, and the cost of manpower and materials can be reduced accordingly.

In some example embodiments, the method 900 can be carried out automatically by software algorithm of robot program design, and the whole processes, including torque loading, test execution, data acquisition, calculation and analysis report, do not need manual intervention. In this way, the test process is simple and efficient.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A fixing platform, comprising:
a baseplate,
a securing component provided on the baseplate;
a balancing weight coupled to a terminal arm of an industrial robot; and
a cylinder provided on the baseplate and adjacent to the securing component, comprising:
a plunger configured to move along a first direction to clamp the balancing weight when the balancing weight is coupled to the securing component.

2. The fixing platform of claim 1, wherein the securing component comprises:
a base part coupled to the baseplate;
a first protrusion extending from the base part; and
a second protrusion extending from the base part,
wherein the second protrusion is spaced from the first protrusion along a second direction perpendicular to the first direction to form a gap between the first protrusion and the second protrusion.

3. The fixing platform of claim 2, wherein the plunger comprises:
a plunger face towards the first protrusion and the second protrusion,
wherein the first protrusion and the second protrusion each comprises a protrusion face towards the plunger,
wherein the protrusion face is parallel to the plunger face, such that the balancing weight can be clamped between the protrusion face and the plunger face when the balancing weight is coupled to the securing component.

4. The fixing platform of claim 2,
wherein the balancing weight is coupled to the terminal arm of the industrial robot via a linkage, and
wherein the linkage can be accommodated within the gap when the balancing weight is coupled to the securing component such that the balancing weight can be supported by the first protrusion and the second protrusion.

5. The fixing platform of claim 1, wherein the plunger can be actuated hydraulically, pneumatically or electrically.

6. The fixing platform of claim 1, further comprising:
a base coupled to a stationary body, wherein the baseplate is coupled to the base.

7. The fixing platform of claim 1, further comprising:
an image capturing module provided adjacent to the securing component and configured to assist in the positioning of the balancing weight onto the securing component.

8. The fixing platform of claim 6, wherein the stationary body is the ground.

9. A method of automatically measuring a backlash of a gear, the gear being coupled between an input shaft and an output shaft, the input shaft being coupled to a motor and the output shaft being coupled to an actuator, the method comprising:
securing the output shaft;
causing the motor to provide a torque for the input shaft to allow the gear to rotate by a degree under the torque;
obtaining the torque and rotated degree of the gear; and
determining the backlash of the gear based on the torque and the rotated degree.

10. The method of claim 9, wherein securing the output shaft is achieved by means of the fixing platform
wherein the fixing platform comprises:
a baseplate,
a securing component provided on the baseplate;
a balancing weight coupled to a terminal arm of an industrial robot; and
a cylinder provided on the baseplate and adjacent to the securing component, comprising:
a plunger configured to move along a first direction to clamp the balancing weight when the balancing weight is coupled to the securing component.

11. The fixing platform of claim 2, wherein the plunger can be actuated hydraulically, pneumatically or electrically.

12. The fixing platform of claim 3, wherein the plunger can be actuated hydraulically, pneumatically or electrically.

13. The fixing platform of claim 4, wherein the plunger can be actuated hydraulically, pneumatically or electrically.

14. The fixing platform of claim 2, further comprising:
a base coupled to a stationary body, wherein the baseplate is coupled to the base.

15. The fixing platform of claim 3, further comprising:
a base coupled to a stationary body, wherein the baseplate is coupled to the base.

16. The fixing platform of claim 4, further comprising:
a base coupled to a stationary body, wherein the baseplate is coupled to the base.

17. The fixing platform of claim 2, further comprising:
an image capturing module provided adjacent to the securing component and configured to assist in the positioning of the balancing weight onto the securing component.

18. The fixing platform of claim 3, further comprising:
an image capturing module provided adjacent to the securing component and configured to assist in the positioning of the balancing weight onto the securing component.

19. The fixing platform of claim 4, further comprising:
an image capturing module provided adjacent to the securing component and configured to assist in the positioning of the balancing weight onto the securing component.
